(19) United States
(12) Patent Application Publication
(10) Pub. No.: US 2007/0265357 A1
(43) Pub. Date: Nov. 15, 2007

(54) Systems for Preparing Fine Articles and Other Substances

(75) Inventors: Steen Brummerstedt Iversen, Vedbaek (DK); Karsten Felsvang, Allerod (DK); Tommy Larsen, Slagelse (DK); Viggo Luthje, Bagsvaerd (DK)

Correspondence Address: KNOBBE MARTENS OLSON & BEAR LLP, 2040 MAIN STREET, FOURTEENTH FLOOR, IRVINE, CA, 92614, US

(73) Assignee: THOMSON LICENSING, F-92100 BOULOGNE-BILLANCOURT, FRANCE (FR)

(21) Appl. No.: 10/583,024

(22) PCT Filed: Dec. 19, 2004
(86) PCT No.: PCT/DK04/00888

§ 371 Date: Mar. 22, 2007

(30) Foreign Application Priority Data
Dec. 19, 2003 (DK) PA2003-01899

(51) Int. Cl. B01J 2/00

(52) U.S. Cl. 516/1; 106/1.22; 118/719; 428/144; 977/773

(57) ABSTRACT

This invention relates to controlled preparation of fine particles such as nano-crystalline films and powders with at least one solvent being in a supercritical state. It provides methods, measures, apparatus and products produced by the methods. In other aspects, the invention relates to further treatment of formed particles such as encapsulation of formed primary particles, and methods and measures for collection of formed substances in a batch wise, semi-continuous or continuous manner.

### FIELD OF INVENTION

This invention relates to controlled preparation of fine particles such as nano-crystalline films and powders with at least one solvent being in a supercritical state. It provides methods, measures, apparatus and products produced by the methods. In other aspects, the invention relates to further treatment of formed particles such as encapsulation of formed primary particles, and methods and measures for collection of formed substances in a batch wise, semi-continuous or continuous manner.

### BACKGROUND

There is an increasing interest in nano- and micron sized materials in numerous technical applications. Such nanostructured fine particle materials in the form of nanocrystalline films and powders are cornerstones in the attempt to develop and exploit nanotechnology. They exhibit properties, which are significantly different from those of the same materials of larger size. During the last decade, the insight into nanostructured materials have dramatically improved through the application of new experimental methods for characterization of materials at the nanoscale. This has resulted in the synthesis of unique new materials with unprecedented functional properties. For nanostructured coatings, physical properties such as elastic modulus, strength, hardness, ductility, diffusivity, and thermal expansion coefficient can be manipulated based on nanometer control of the primary particle or grain size. For nano structured powders parameters such as the surface area, solubility, electronic structure and thermal conductivity are uniquely size dependent.

The novel properties of such nanostructured materials can be exploited and numerous new applications can be developed by using them in different industries. Examples of potential applications include new materials such as improved thermoelectric materials, electronics, coatings, semiconductors, high temperature superconductors, optical fibres, optical barriers, photographic materials, organic crystals, magnetic materials, shape changing alloys, polymers, conducting polymers, ceramics, catalysts, electronics, paints, coatings, lubricants, pesticides, thin films, composite materials, foods, food additives, antimicrobials, sunscreens, solar cells, cosmetics, drug delivery systems for controlled release and targeting, etc.

Addressing and exploiting such promising applications with new materials generally requires an improved price-performance ratio for the production of such nanostructured materials. The key parameters determining the performance are the primary particle (grain) size, size distribution of the primary particles, chemical composition and chemical purity as well as the surface area of powders, while the primary parameters for in relation to price are the ease of processing and suitability for mass production.

Several techniques have been used in the past for the manufacture of micron- or nano sized particles. Conventional techniques for submicron powders include spray drying, freeze drying, milling and fluid grinding, which are capable of producing powders in the micrometer range. Manufacturing techniques for producing submicron materials include high temperature vapour phase techniques such as flame synthesis and plasma arc methods, which allow production of nano-scaled powders consisting of hard or soft agglomerates of primary particles.

Solution sol-gel and hydrothermal synthesis are the major low temperature processes for production of fine particles with nano-scaled primary particles or grains. Hydrothermal synthesis is used for synthesis of a wide range fine oxide powders. The term hydrothermal relates to the use of water as reaction medium and regime of high pressure and the medium to high temperature applied. A major drawback is the relatively long reaction time required at for at low to medium temperatures and the very corrosive environment at higher temperature.

Sol-gel processing is widely used as it is a versatile technology that allows production of homogeneous high purity fine particles with a relatively small primary particle size to be produced from numerous materials in the form of powders, films, fibres, spheres, monoliths, aerogels, xerogels as well as coatings. The precursors can be metal organics, metals, inorganic salts etc. The processing temperatures are generally lower than for hydrothermal synthesis.

The key drawbacks from the sol-gel process are that it is that it is time consuming, and need after treatment such as drying and calcinations. In the traditional sol-gel process, it is necessary to calcine the product for up to 24 hours in order to obtain a crystalline product. In addition to a higher energy usage and a more complicated process this has the unfortunate effect that substantially growth of primary particles occur, and that the specific surface area may be decreased by up to 80%.

Supercritical Fluids

Supercritical fluids exhibits particular attractive properties such as gas-like mass transfer properties like diffusivity, viscosity, and surface tension, yet having liquid-like properties such as high salvation capability and density. Furthermore, the solubility can be manipulated by simple means such as pressure and temperature. This tunable solvation capability is a unique property that make supercritical fluids different from conventional solvents. Another major advantage of supercritical fluids is that rapid separation of solutes can easily be achieved by reduction of pressure. These attractive properties of such fluids at supercritical conditions have attracted considerable attention for its potential applications as environmentally friendly solvents for chemical processing. Carbon dioxide is the most widely used fluid for dense fluid applications, because of its moderate critical constants (T_{c}=31,1 C, P_{c}=72,8 atm, and (φ_{c}=0.47 g/cm³), non-toxic nature, low cost, and availability in pure form.

Supercritical CO₂ are today a mature technology, which are commercially being applied in large scale for extraction applications such as decaffeination of coffee and tea, extraction of hops, spices, herbs and other natural products. More recently supercritical fluids such as supercritical CO₂, have been applied for commercial applications within impregnation.

Production of micron and submicron sized powders by supercritical techniques have been a hot scientific topic since the beginning of the nineties. The development has particularly been focused on physical transformation processes. They are generally variations of two primary methods for particle precipitation in supercritical fluids, the Solvent-AntiSolvent technique (SAS) and the Rapid Expansion of Supercritical Solutions technique (RESS).

SAS Technique

In the SAS technique, the material of interest is first dissolved in a suitable organic solvent, and the solution is subsequently mixed with a supercritical solvent, which dissolves the solvent and precipitates the solids out as fine particles.

RESS Technique

In the RESS technique, the solid of interest is first dissolved in a supercritical fluid and thereafter expanded by spraying through a nozzle. The expansion through the nozzle causes a dramatic reduction in the CO2 density and thereby a dramatic reduction in the solvent capacity, causing high supersaturation resulting in the formation of fine particles.

Derived techniques from the SAS and RESS techniques are for example Solution Enhanced Dispersion by Supercritical Fluids Techniques (SEDS) and Precipitation with compressed Antisolvent technique (PCA), which is based on the concept of coupling the use of a supercritical fluid as a dispersing agent, by means of a coaxial nozzle, in addition to its primary role as an antisolvent and a vehicle to extract the solvent. Further extensions of this technique include multiple concentric opening nozzles.

Other techniques include Precipitation from Gas-Saturated Solutions (PGSS), which involves melting the material to be processed, and subsequently dissolving a supercritical fluid under pressure. The saturated solution is then expanded across a nozzle, where the more volatile supercritical fluid escapes leaving dry fine particles.

All these techniques have been successfully used in small scale to produce micron sized particles of various materials for numerous applications. Excellent reviews of prior art supercritical particle formation processes can be found in e.g. Ya-Ping Sun(“Supercritical Fluid Technology in Materials Science and Engineering—Syntheses, Properties and Applications, Marcel Dekker Inc., 2002-ISBN: 0-8247-0651-X), Gentile et al (WO03/035673A1), Gupta et al (US2002/0000681A1), Mazen et al (EP0706421B1), Del Re et al (WO02/068107A2), Mazen et al (WO99/44733), Calfors et al, Jagannathan et al (WO03/053561), all of which are hereby included by reference.

However, all these techniques suffer from some inherent limitations. The RESS technique is limited by the solvent capacity in the supercritical fluid. For example, supercritical carbon dioxide, which is a preferred solvent in many applications, is limited by a low solubility towards polar substances. Modifiers such as co-solvents and surfactants may be added to the supercritical carbon dioxide to improve the solubility of the material of interest. However, such co-solvents and surfactants may remain in the precipitated product as impurities, which may not be acceptable. Further drawbacks of the RESS technique includes that the isenthalpic expansion over the nozzle that results in large temperature drops, which can cause freezing of the solid and carbon dioxide and thereby cause blocking of the nozzle. The nozzle design is further critical for the final particle characteristics such as size and morphology etc. All these drawbacks from microscopic variables limit the control over the process itself, and make scale-up relatively difficult. Still further such systems are in its present embodiment generally limited to non-reacting or extremely fast reacting systems as the change of solubility is caused momentary.

Due to the higher solubility the SAS technique and its derivatives generally have higher through-puts, and generally produce particles in the range 1-10 micron (Gupta et al, US2002/0000681A1). The key and particle size controlling step of the SAS techniques is the mass transfer rate of the antisolvent into the droplet. Hence, mixing of solution and the supercritical fluid is crucial in order to obtain an intimate and rapid mixing, a dispersion of solution as small droplets into the supercritical fluid is required. Various nozzle designs have been proposed to inject solution and supercritical fluid into a particle formation vessel in order to provide a good mixing. Recent modifications of the SAS technique to reduce the particle size includes atomization techniques such as special designed coaxial nozzles, vibrational atomization, atomization by high frequency sound waves, ultrasonic atomization etc. (US2002000068A1). Though these modified techniques are believed to provide enhanced mass transfer and resulting reduced particle sizes, too rapid particle formation may reduce the control of the size and morphology such as crystallinity of the formed particles, be sensitive to the nozzle design and blockages of the nozzle and be difficult to scale-up. A further drawback is that the SAS techniques are generally not suitable for reactive systems in large scale.

### DESCRIPTION OF THE INVENTION

A major shortcoming in the widespread commercial exploitation of nanotechnology has so far been large scale production of fine particles with sufficient homogeneity and reproducibility at affordable costs so as to make them competitive in the market.

Fine particles in the present context generally comprise primary particles such as grains, crystallites and the like. It should be understood that the fine particles in this context, shall preferably be interpreted in broad terms. Said fine particles may comprise anything from a single primary particle, a cluster or clusters of primary particles, agglomerates of primary particles such as a powder, a film or a coating of said primary particles or even a bulk material comprised by said primary particles.

Different aspects of the present invention seek to meet one or more of the following objectives:

An objective of present invention is to address the quality and availability of such fine particles by providing method(s) for production of such materials, which allows production of more homogeneous fine particles than in the prior art i.e. fine particles with a high purity and/or a controlled particle morphology, and/or a small average diameter and/or a narrow size distribution, and/or a controlled phase and/or structure.

Another objective of the present invention is to provide method(s), which allow such high quality materials to be produced at shorter processing times and/or at lower temperatures and/or with a more controlled growth rate and/or with a more controlled morphology such as a more controllable crystallinity or shape than hitherto.

Still another objective of the present invention is to provide method(s) suitable for large scale production of fine particles with more uniform and/or homogeneous properties.

A further objective of the present invention is to provide improved methods and measures for introducing fluid(s), and/or chemical reactant(s) and/or initiator(s) and/or precursor(s) and/or catalyst(s) into a vessel.

A still further objective of the present invention is to provide improved methods and measures for controlling a chemical reaction in a dense fluid under near or supercritical conditions.

Still another further objective of the present invention is to provide methods which reduce or eliminates the needs for post processing steps such as drying and calcinations.

Furthermore, an objective of the present invention is to provide methods and measures for the collection the fine particles in both a batch wise manner and a continuous manner.

It may also be an objective of the present invention to provide an apparatus for production of fine particles according to the above described method.

Additionally, it may be an objective to provide a product obtained by the above described methods, and applications for use of said product.

These objectives and the advantages that will be evident from the following description are obtained by the following preferred embodiments of the invention.

In a first aspect, the present invention of relates to the production of fine particles. Hence, a preferred embodiment of a method according to the present invention comprises producing a fine particle material by
i) introducing one or more substances contained, such as dissolved and/or dispersed in one or more fluid(s) into a vessel by introducing said fluid(s) into the vessel, said vessel containing one or more section(s) comprising a material, at least one of the fluids being in a supercritical state before or after being introduced into said vessel,
ii) causing and/or allowing said substances to precipitate at least partly as primary particles on the surface of said material.

In many embodiments according to the present invention, the method relates to the production of fine particles comprising nanoscaled primary particles i.e. primary particles having an average diameter smaller than 100 nanometer such as smaller than 30 nanometer, and even more preferable primary particles having an average diameter of smaller than 15 nanometer such as an average diameter smaller than 10 nanometer.

As the primary particles may have an irregular shape, the average diameter in this context shall preferably be interpreted as an equivalent spherical diameter. Various methods of varying quality exist for the determination of the size of nanoscaled primary particles including X-Ray Diffraction (XRD), Small Angle X-ray Scattering (SAXS), Transmission Electron Microscopy (TEM), Scanning Electron Microscopy (SEM). The microscopic techniques may lead to inaccuracies, and it is recommended to apply the X-ray techniques. The above average diameters refers to diameters determined by the SAXS technique by applying the Beaucage model [G. Beaucage et al, Journal of Non-crystalline Solids 172-10 174, p. 797-805, 1994]. This method is considered as reliable and widely applicably as it allows determination of the average diameter of both amorphous and crystalline phases.

Many preferred embodiments according to the present invention relates to the production of very uniform and homogeneous fine particle materials having a very narrow size distribution.

Hence, a method according to the present invention often comprises fine particles, wherein the standard deviation of the size distribution of the average diameter of said primary particles formed is often less than 60% of the average diameter, such as 40% of the average size of said primary particles, and preferably less than 30% of the average size of said primary particles such as less than 20% of the average size of said primary particles, and even more preferably the standard deviation of the size distribution of said primary particles formed is less than 15% of the average diameter of said primary particles.

A preferred embodiment of the present invention relates to the production of fine particles wherein the standard deviation of the average diameter of said primary particles formed is maximum 20 nanometer, such as maximum 10 nanometer, and preferably less than 5 nanometer, and even more preferably less than 3 nanometer. The above mentioned standard deviation may be derived from SAXS data or similar high quality data.

The present invention generally relates to a method, wherein at least one of said fluids is/are in a supercritical state before or after being introduced into said vessel. In a preferred embodiment said fluid(s) being in a supercritical state is/are preferably selected from the group consisting of carbon dioxide, alcohols such as methanol, ethanol, propanol, isopropanol, buthanol, sec-buthanol, pentanol, hexanol, water, methane, ethane, propane, buthane, pentane, hexane, cyclohexane, heptane, ammonia, sulfurhexafluoride, nitrous oxide, chlorotrifluoromethane, monofluoromethane, acetone, THF, acetic acid, citric acid, ethylene glycol, polyethylene glycol, N,N-dimethylaniline and mixtures thereof.

In particular preferred embodiments at least one of the fluid(s) may be CO₂ and/or an organic solvent and/or water.

In another embodiment said fluid may further comprise at least one co-solvent preferably selected from the group consisting of alcohol(s), water, ethane, ethylene, propane, butane, pentane, hexane, heptane, ammonia, sulfurhexafluoride, nitrous oxide, chlorotrifluoromethane, monofluoromethane, methanol, ethanol, propanol, isopropanol, buthanol, pentanol, hexanol, acetone, DMSO, THF, acetic acid, ethyleneglycol, polyethyleneglycol, N,N-dimethylanillne and mixtures thereof.

In yet another embodiment said fluid may also comprise one or more surfactants, said surfactants being preferably selected from the group consisting of hydrocarbons and fluorocarbons preferably having a hydrophilic/lipophilic balance value of less than 15, where the HLB value is determined according to the following formula: HLB=7+ sum(hydrophilic group numbers)−sum(lipophilic group numbers).

The pressure of at least one of said fluids being in a supercritical state before or after being introduced to the vessel may be In the range 85-500 bar, preferably in the range 85-350 bar, such as in the range 100-300 bar. In embodiments, wherein said fluid(s) being in a supercritical state before being introduced to the vessel and not within the vessel said fluid(s) often undergo an expansion into said vessel according to methods well known in the prior art.

However, many preferred embodiments of the present invention relates to methods, wherein the at least one of said fluid(s) being introduced into said vessel, is in an supercritical state also after introduction into said vessel. In such embodiments the pressure within the vessel may be in the range 85-500 bar, preferably 85-350 bar such as in the range 100-300 bar.

The absolute temperature depends of the actual fine particles to be produced and may in many embodiments according to the present invention be maintained in the range 20-500 C., such as 30-450° C., and preferable in the range 35-200° C., and more preferable in the range 40-150° C.

The precipitation is generally caused by change of the solubility of at least one of said substances. The change of said solubility may be performed in a number of ways depending of the specific particle formation application.

In one embodiment, said changing of the solubility involves mixing said fluid(s) containing said dissolved and/or dispersed substances with an antisolvent capable of dissolving at least partly at least one of said fluid(s) and/or a reaction product formed by a chemical reaction occurring as a result of said mixing. The antisolvent may be in a gaseous, liquid or a supercritical state. The antisolvent may be present in the vessel prior to introducing said fluid(s) and/or may be introduced into said vessel together with said high surface area material at one or more points.

In another embodiment said changing of the solubility of at least one of said substances, may be to expand the fluid(s) containing said substances into the vessel through one or more nozzles such as performed in the Rapid Expansion of Supercritical Solvent (RESS) and the Rapid Expansion of Supercritical solvent into a Liquid (RESOLV) techniques. Still another embodiment involves changing the solubility by changing the temperature of said fluid.

In a preferred embodiment according to the present invention, at least one of said dissolved and/or dispersed substances in said fluid(s) undergoes a chemical reaction. Said reaction may be a reaction according to the so-called sol-gel route. Traditional sol-gel processing Is versatile and widely used reaction route, which allows synthesis of a wide range of materials including oxides, hydroxides, oxyhydroxides, nitrides, carbides etc. of e.g. metals or semi-metals.

A good description of the traditional sol-gel synthesis method for e.g. making fine ceramic fibers as described in e.g. YA-Ping Sun,“Supercritical Fluid Technology in Materials Science and Engineering—Syntheses, Properties, and Applications”, Marcel Dekker, 2002, ISBN:0-8247-0651-X hereby included by reference. It involves forming an aqueous dispersion of oxide particles that is then gelled either by concentrating the dispersion by solvent removal or by carrying out a chemical reaction. For example, one method of sol gel synthesis is to start with a metal alkoxide solution and add a small amount of water to control the hydrolysis and condensation of metal hydroxides. As the sol is dried, these metal hydroxides form a polymeric network through cross linking of the metal oxygen bonds. The method of drying greatly influences the final product morphology. Supercritical drying has been shown to produce soft aggregates that can be broken down to a powder. The resulting powder is typically subjected to heat treatment to induce the complete dehydration and crystallization of oxide particles. Another method of sol-gel synthesis is to start with a solution of a metal salt and a water-soluble polymer. By adding a base to this solution, the metal salt can be converted to metal hydroxides, while the polymer cross-links to form a porous network around these metal hydroxides. In this case, the polymer network serves to prevent significant growth and aggregation of the metal hydroxides, so that it is possible to obtain nanomaterials using this technique. Nanomaterials of a number of ferrites including CoFe₂O₄, NiO,5 ZnO, 5 Fe₂O₄—SiO₂, BaFe₁₂O₁₉ and GeO,5 Fe2,50_{y} have been prepared using sol-gel synthesis.

In an embodiment of the present Invention a sol-gel reaction may be performed with an alkoxide precursor dissolved in e.g. supercritical CO₂ and/or an alcohol such as ethanol, isopropanol, buthanol and/or super. The metal alkoxide reacts readily with water to produce metal oxides and/or metal hydroxides. Compared with samples made via conventional sol-gel syntheses, supercritical synthesized powders exhibit a higher degree of crystallinity and contains less hydroxide.

A particular advantageous embodiment of present invention leading to improved control of the properties of the primary particles formed may involve introducing the reactants sequentially. In such embodiments according to the present invention, it is advantageous to introduce at least one reactant(s) and/or precursor and/or initiator(s) and/or catalyst(s) into the vessel at least partly prior to introducing said fluid(s) containing said substances and vice versa.

Furthermore, in an embodiment according to the present invention such sequential or stepwise introduction of reactants may be repeated multiple times e.g. by introducing into the vessel at least one of said reactant(s) and/or precursor(s) and/or initiator(s) for said chemical reaction and subsequently introducing into the vessel one or more substances dissolved and/or dispersed in or mixed with at least one fluid or vice versa.

Additionally, such multiple sequential steps may also involve one or more of the following processes: RESS (rapid expansion of supercritical solutions), GAS (Gas Antisolvent), SAS (solvent Anti Solvent), SEDS (Solution Enhanced Dispersion by supercritical fluid), PCA (Precipitation with Compressed Antisolvent), PGSS (Precipitation from Gas-saturated Solutions) and variations thereof either prior to introducing into the vessel at least one of said reactant(s) and/or precursor(s) and/or initiator(s) for said chemical reaction and subsequently introducing into the vessel one or more substances dissolved and/or dispersed in or mixed with at least one fluid, or after one or more of such sequential steps.

It may further be advantageous, if said material is capable of adsorbing at least one of said reactant(s) and/or precursor(s) and/or initiators(s) and/or catalyst(s), and preferably in substantially a monolayer. Hereby said reactant can be evenly distributed on said high surface area material thereby resulting in a very controllable reaction and/or fine particle formation process.

The temperature in the vessel may be selected so as to control the specific properties of the primary particles formed e.g. crystallinity, particles size and phase. A higher temperature generally leads to higher reaction rates, but also reduces the control of the specific properties. A particular feature of the present invention may be that it allows controlled production of homogeneous materials at higher reaction rates and lower temperatures than hitherto.

As described above the temperature in the vessel during said sol-gel reaction generally depend on the specific fine particle material to be produced. In many preferred embodiments the maximum temperature in the vessel during said sol-gel reaction(s) may be maintained below 400 C., such as below 300 C., preferably below 250 C. such as below 200 C., and even more preferably below 150 C. such as below 100 C.

The temperature may further be maintained constant during each of said sequential steps, or may be varied according to a pre-selected schedule. In embodiments, wherein different materials are produced in the individual steps the temperature and/or pressure may further be varied between each of such individual steps.

In some embodiments according to the present invention the time for said chemical reaction may be relatively long such as less than 24 hours, such as less than 12 hours, and preferable less than 8 hours such as less than 4 hours.

In a preferred embodiment according to the present invention the time for said chemical reaction(s) is maximum 2 hours, such as maximum 1 hour, preferably less than 30 minutes and even more preferably less than 15 minutes.

The material being present in said one or more sections according to many embodiments of the present invention may have a number of functions. In some embodiments according to the present invention, it may serve as a distributor enabling a more uniform distribution of the substances being introduces into the vessel, and thereby improve the homogeneity of the fine particle material(s) being formed.

In other embodiments to the present invention the material may provide a large number of nucleation sites so as to provide a high nucleation rate compared to the particle growth rate. Hereby, a seeding effect may be introduced, thus ensuring a fine control of the fine particles formed. In some embodiments the seeding effect may further be increased by introducing an ultrasound and/or a vibrating effect. In other embodiments said seeding effect may further be at least partly provided by seed particles.

The material may be arranged in a number of ways in said one or more section(s) of said vessel. The vessel may be whole or partly filled with said material. In many embodiments according to the present invention the material may comprise a porous structure and the fraction of the total volume comprised by said material in said one or more sections may be up to 70%, such as up to 50%, preferably up to 30% and even more preferably up to 20%.

In one embodiment according to the present invention said particles may be in a fluidised or suspended state in said one or more section in the vessel. In a further embodiment according to the present invention the material may comprise the same material as said primary particles.

The porous structure of said material in said one or more sections may have any shape, such as a sheet, a fibrous, a spongeous or a grid structure. In a preferred embodiment according to the present invention said material present in said one or more sections may be a template for forming and/or curtailing said primary particles into a specific shape, size, structure or phase.

The material may comprise a wide range of materials depending on the specific application. In many embodiments according to the present invention the material may be selected so as to provide a specific functionality. One such functionality may be the capability to adsorb specific compounds on the surface, whereby specific properties of the formed fine particle product may be controlled e.g. average particle diameter and size distribution.

In an embodiment according to the present invention involving water as a precursor/initiator for a reaction, the material may be selected so as to provide a large adsorption capacity for water. In such cases a hydrophilic material is selected.

In another embodiment it may be desired to obtain a selective adsorption of another substance e.g. an alkoxide. In such embodiments a less hydrophilic or a hydrophobic material may be selected.

In many embodiments according to the present invention said material may comprise a polymer material such as a polymer or elastomer selected from the group consisting of polyethylene, polypropylene, polystyrene, polyesters, polyethylene terephtalate, polyvinyl chloride, polyvinyl acetates, polyoxymethylene, polyacryloamide, polycarbonate, polyamides, polyurethane, copolymers thereof, chlorinated products thereof, rubbers and chlorinated rubber, silicone rubbers, butadiene rubbers, styrene-budiene-rubbers, isoprene polymers, vulcanised fluororubbers, silicone rubbers.

In a preferred embodiment according to the invention the polymer material may be polypropylene. In another preferred embodiment according to the present invention the material may comprise an elastic material. In still another preferred embodiment according to the present invention may be a ceramic material such as glass wool such quartz wool.

In a further embodiment according to the present invention the material may comprise a porous media such as an aerogel. In a particular preferred embodiment according to the present invention said aerogel may be produced within the same equipment by producing said aerogel material by
a sol-gel reaction in an organic solvent
removing said organic solvent by extraction in supercritical CO₂
drying at least partly said aerogel by supercritical CO₂
forming said primary particles on the surface of said aerogel according to the present invention.

In still another embodiment of the present invention said porous media material may comprise as a heterogeneous catalyst support material or a heterogeneous catalyst.

In many embodiments according to the present invention said material may comprise a high surface area material. Such high surface area materials according to the present invention may have a specific surface area (m²/m³) of said material in said sections is above 500 m²/m³, such as 1000 m²/m³, such as above 10.000 m²/m³, and preferably above 50.000 m²/m³ such as above 100.000 m²/m³.

The high surface area material may comprise a plurality of fibres. Various ways of arranging such fibres are known in the prior art (e.g. W. S. Winston Ho et al et al, “Membrane Handbook”, Van Nordstrand Reinhold, 1992, ISBN 0-442-23747-2, K. Scott, “Handbook of Industrial Membranes”, Elsevier Science Publicers, 1995, ISBN 1856172333, Iversen et al, WO95351153, Iversen et al, WO00160095, U.S. Pat. No. 690,830, U.S. Pat. No. 5,690,823) and are hereby included by reference. Such methods Includes random packings, mats, cloths, bundles, twisted bundles, meshs, arrays, etc.

In an embodiment of the present invention said fibres may comprise a plurality of fibres extending in substantially the same direction, such as in a filtration medium. One way of packing such fibres relevant to the present invention is disclosed in U.S. Pat. No. 5,690,823 hereby included by reference.

In the present description with claims the term the term “hollow tubular member(s)” comprises hollow fibres, and other hollow tubular bodies having any cross section, e.g. a hollow tubular chamber. Likewise the term surface of a membrane and similar expressions are intended to mean at least part of a membrane surface.

In general it may be advantageous to introduce at least partly one of said fluids into said vessel through the walls of at least one hollow tubular member comprising an inner and an outer surface, and having at least one end communicating with the outside of said vessel. At least part of said hollow tubular member(s) comprising a membrane. Said membrane may comprise a so-called dense membrane. The term dense membrane is known by a man skilled in the art, and is intended to designate membranes having at least one layer being substantially nonporous i.e. having pores of substantially molecular dimensions.

In many embodiments according to the present invention, the membrane(s) is porous. In other applications such membranes are used for filtration of e.g. liquids (nanofiltration, ultrafiltration, microfiltration etc.), and have pores within the range 0.001-100 micron, such as pores in the range in the range 0.01-10 micron, and preferably in the range 0.01-0.1 micron.

In some embodiments in accordance with the present invention such hollow tubular members may be used for introducing at least one of said fluid(s) into the vessel in a very uniform manner. In such embodiments the high surface are may comprise both hollow tubular member(s) and other high surface area materials such as a nonporous fibre material. The hollow tubular member(s) may also comprise several sets of hollow tubular member(s) for introducing different fluids to the vessel. Various examples integrating of said hollow tubular member(s) in the vessel are further illustrated in the figures.

In a particular preferred embodiment for many applications, the hollow tubular member(s) constitutes said high surface area material. In such embodiment a fluid and/or reactant(s) and/or initiator and/or precursor may be added to substantially the outer surface of said tubular member(s).

An important embodiment of the present invention may comprise re-circulating in at least part time of the method at least part of a fluid mixture present in the vessel, the recirculating comprising:
withdrawing from the vessel at least a part of a fluid from the vessel and feeding it to a re-circulation loop and subsequently feeding the fluid back to the vessel.

A preferred embodiment according to the present invention may further comprise the step of controlling the temperature of the fluid in the re-circulation loop by adding or extracting heat from said fluid in said re-circulation loop.

In another preferred embodiment one or more reactant may be added and/or extracted from the fluid in said re-circulation loop, hence allowing precise control of said reactant concentrations during said fine particle material reaction. Still another preferred embodiment may involve controlling the concentration of an alcohol, an alkoxide and/or water. A further preferred embodiment according to the present invention may comprise controlling the temperature- and/or pressure- and/or density- and/or concentration profiles within the vessel. Such embodiment increases the mass- and an heat transfer within the vessel and allow precise control of the fine particle material being formed.

In a particular preferred embodiment a metal- or semi metal alkoxide are produced in-situ in the recirculation loop e.g. by applying an electrochemical synthesis of said metal or semi-metal in the corresponding alcohol. Said metal or semi-metal alkoxide may be introduced Into said vessel in various ways such as exemplified in the FIGS. 7-8, and in illustrative example 1.

An important embodiment according to the present invention may be where said material within said one or more sections in vessel with said precipitated primary particles thereon comprises the final product. Non-limiting examples of such product according to such embodiment comprises a tape cast with said primary particles deposited on a carrier film. Alternatively, wherein said primary particles on said surface of said material constitutes a film or a coating.

A particular preferred embodiment according to the present invention may be wherein said film or coating has one or more layer(s) each layer having a layer thickness of up to 1 micron, such as a layer thickness below 500 nanometer, preferable a layer thickness below 250 nanometer such as a layer thickness below 100 nanometer. Even more preferable the layer thickness of said film is below 50 nanometer, such as a layer thickness below 30 nanometer. Additionally, said coating or film on said material may comprise multiple layers, and optionally these layers may comprise different materials.

Another embodiment according to the present invention may comprise subjecting said coating or film to an annealing process. In a preferred embodiment said annealing process may be performed by microwaves. Such has may advantages compared to conventional thermal annealing as it is clean and simple, energy and cost efficient and has a short reaction time. It may further be integrated in the production process. Another distinct advantage Is that it may be applied for annealing coating or films on materials such as glass and polymers, where the conventional thermal annealing process is a limiting factor.

A further embodiment according to the present invention may be related to deposition of said primary particles on the surface of said material in the form of small clusters of individual particles and preferably as individual particles. This has become possible due to the elimination of the normal drying phenomena related to wet deposition methods, by applying a highly tuneable supercritical process according to the present invention. In an preferred embodiment according to the present invention said clusters may comprise up to 100 atoms, such as up to 50 atoms, and preferably less than 10 atoms and even more preferably less than 5 atoms. A particular preferred embodiment said clusters and/or individual particles may be deposited as quantum dots.

A further embodiment according to the present invention may be where said primary particles precipitated on said surface of the material present in said one or more section(s) are removed from said material as a powder. In most embodiment according to the present invention said powder consists of weakly bounded soft agglomerates of primary particles. In many of such embodiments according to the present invention said soft weakly bounded agglomerates may have a size of maximum 10 micron, such as up to 5 micron, and preferably up to 1 micron such as up to 500 nanometer.

In a preferred embodiment according to the present invention said powder may be removed from said material by introducing a vibrating effect and/or an acoustic effect such as ultrasound waves and/or by back flushing and/or by applying a pressure pulse effect. The vibrating effect may in an embodiment according to the present invention be generated by piezoelectric means.

Alternatively said vibrating effect may be generated by a magneto-restrictive means in accordance with an embodiment of the present invention.

In a particularly preferred embodiment according to the present invention said material may be removed within the vessel, thus allowing for continuous or semi-continuous operation.

The removal of said removed powder from said material may be withdrawn from the vessel by flushing with a fluid or fluid mixture present in the vessel in accordance with an embodiment of the present invention.

Additionally, said fluid containing said formed powder may be fed into a second vessel containing a liquid in accordance with the present invention, and thereby providing said powder material as a dispersion in said liquid.

Alternatively, said fluid containing said powder may be fed to a bag filter or a ceramic filter for separation of said formed powder material from said fluid. Furthermore, said formed particulate material may be fed to a membrane separation device.

In another preferred embodiment according to the present invention, a coating or encapsulation step may be performed. In a particular preferred embodiment said coating or encapsulation step(s) may be performed at least partly during harvesting/removing said particles from said material.

The present invention is applicable for production of fine particles from a wide range of materials. Preferred embodiments according to the present invention include the production of primary particles wherein said primary particles comprises oxide(s), oxyhydroxide(s), hydroxide(s) such as metal oxide(s), semi-metal oxide(s), metal oxyhydroxide(s), semi-metal oxyhydroxide(s), metal hydroxide(s), semi-metal hydroxides and combinations thereof.

Such preferred embodiments according to the present invention further include oxide materials such as electro-ceramic materials, semi-conducting materials, piezoelectric materials, and magnetic, ferromagnetic, paramagnetic, or super-paramagnetic materials.

In particular preferred embodiments according to the present invention said oxide materials may comprise oxides of one or more of the following elements: Al, Si, Ti, Zr, Zn, Fe, Ni, Co, Ce, Ge, Ba, Sr, W, La, Ta, Y, Mn, V, Bi, Sn, Te, Se, Ga, Be, Pb, Cr, Mg, Ca, Li, Ag, Au, Pt, Pd, Cd, Mo, Eu and combinations thereof.

In other embodiments according to the present invention said metal or semi-metal is/are precursors for a thermoelectric material. In an embodiment according to the present invention such materials materials are produced by applying a reducing agent to form a thermoelectric material.

In a preferred embodiment said thermoelectric material formed may comprise a clathrate, preferably comprising one or more of the following elements: Ba, Bi, Te, Se, Zn, Sn, Sr, Ga, Ge, Pb, Cd, Sb, Ag, Si and combinations thereof. An advantage of the present invention for such embodiments is that the small primary particles and the narrow size distribution according to the present invention introduces an additional heat conductivity barrier between the primary particles.

Hence, in a preferred embodiment of the present invention a thermoelectric material having a thermal conductivity at temperatures above 20 C. of maximum 10 watts per meter Kelvin, such as maximum 5 watts per meter Kelvin, preferably maximum 3 watts per meter Kelvin such as maximum 1.5 watts per meter Kelvin, and even more preferably a heat conductivity of maximum 1 watt per meter Kelvin may be produced. The primary particles of said thermoelectric material may further be doped with metals and/or semi-metals to improve the electrical conductivity of said material.

In second aspect of the present invention it further comprise an apparatus comprising one or more of the means disclosed in any of the preceding claims and being adapted to carry out the method according to the invention.

In a third aspect the present invention also relates to a product obtainable according to the invention.

A preferred embodiment according to the present invention may comprise a tape cast for tape casting, comprising primary particles deposited on a carrier film, wherein said primary particles have:
a. an average diameter of less than 100 nanometer such as an average diameter of less than 30 nanometer, preferably an average diameter of smaller than 20 nanometer and even more preferable an average diameter below 15 nanometer such as below 10 nanometer.
b. a narrow size distribution around the average diameter characterized by having a maximum standard deviation of said distribution of maximum 20 nanometer, such as maximum 10 nanometer, and preferably less than 5 nanometer.

Another embodiment according to the present a piezomotor may be produced from a lead zirconate titanate tape cast.

An important embodiment according to the present invention may comprise an item having a hard nanocrystalline coating comprising primary particles of Al₂O₃ and Zro₂ according to any of the preceding claims, wherein said coating has a hardness of at least 10 GPA, such as a hardness of at least 15 GPA, and preferably above 20 GPA, and even more preferably a hardness of at least 25 GPA.

A further embodiment according to the present invention may comprise an item having a hard nanocrystalline coating comprising primary particles of Al₂O₃ and ZrO₂ according to any of the preceding claims, wherein said coating has a scratch and wear resistance of at least 30 N, such as a scratch and wear resistance of at least 35 N, preferably a scratch and wear resistance of at least 40 N, and even more preferably a scratch resistance of at least 45 N.

It is well known in the prior art that a number of physico-chemical properties are uniquely size dependent, and that manipulation of such size dependent properties allow tailoring materials to specific applications.

The primary particles according to an embodiment to the present invention may be highly chemically pure and very homogeneous with a small and tunable average diameters and a very narrow size distribution. Further said primary particles may be present in the form of a coating, a dry powder or in the form of a liquid suspension.

It will be known to a person skilled in the art that a number of applications for such products exist or may developed including the applications mentioned In the described under back ground in this document.

### DESCRIPTION OF THE DRAWINGS

The following abbreviations applies to the figures below:

F: Fluid

F1: Fluid 1

F2: Fluid 2

HSAM: High surface area material

FP: Formed particles

PH: Particle harvesting

HTM: Hollow tubular member

FIG. 1 shows an example of a vessel containing a high surface area fibre material according 35 to the present invention. The high surface area material is contained in a vessel having one or more inlets for introducing one or more fluids. The vessel may be horizontally or vertically positioned. A randomly packed fibre material is illustrated in FIG. 1b. FIG. 1c shows a reactant (black triangles) adsorbed to said fibre material. FIG. 1d shows said primary particles formed on the surface of said fibre surface, and FIG. 1e shows the harvesting said deposited particles

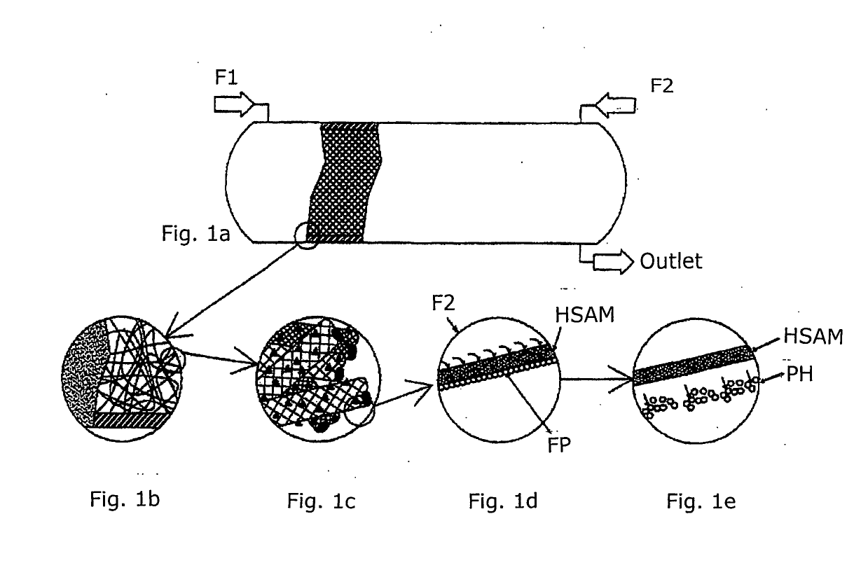

FIG. 2 shows an example of a vessel similar to the one in FIG. 1, but further comprising a hollow tubular member blocked in one end to distribute said first fluid. It should be understood that the vessel may constitute a plurality of such tubular members.

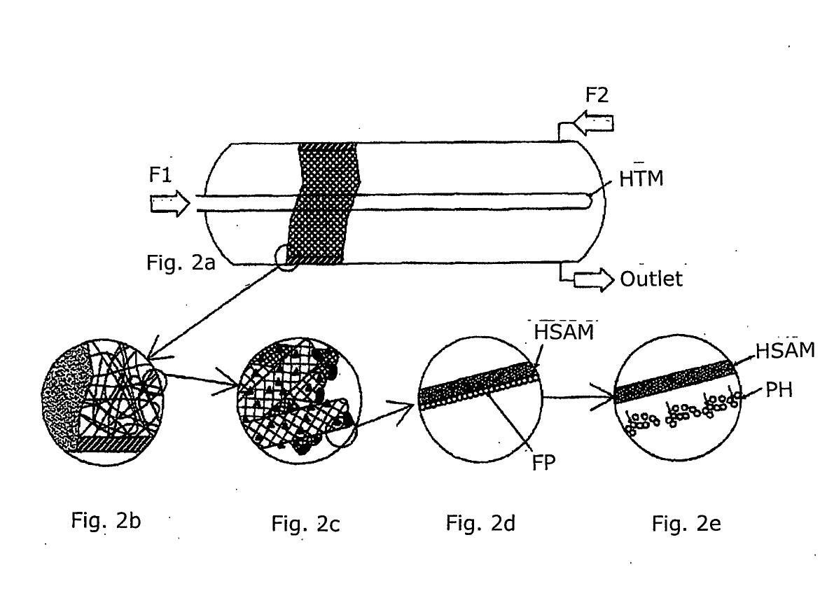

FIG. 3 shows a vessel containing a high surface area material according to the present invention comprising a plurality of fibres extending in substantially the same direction and with both ends communicating with the outside of said vessel. The vessel may have one or more inlets communicating with the outside of said vessel for introducing one or more fluids, and the vessel may further have one or more outlets for withdrawing said fluids and/or said particles formed. It should be understood that in addition to said high surface area material, the vessel may further comprise hollow tubular member(s) with one or both ends communicating with the outside of said vessel.

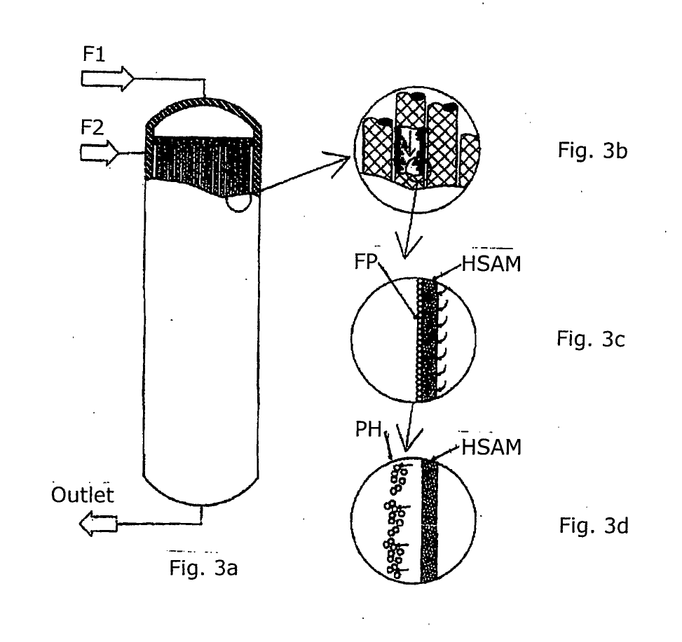

FIG. 4 illustrates a vessel similar to the one in FIG. 3, but further comprising a plurality of hollow tubular members extending in substantially the same direction and communicating with both an inlet and an outlet plenum. The first fluid is introduced into said inlet plenum and is distributed to the inner surface of said tubular member(s). At least part of said fluid permeating through the membrane walls of said tubular members so as to obtain a controlled addition of said first fluid and/or dissolved substances to fluid on the outer surface of said hollow tubular members, thereby resulting in a precise control of the concentration of said fluid and/or dissolved substances within the vessel. The temperature within the vessel may further be precisely controlled by controlling the flow rate and inlet temperature of said first fluid. This is preferably accomplished by withdrawing in at least part of said particle formation process said first fluid from said outlet plenum to an external re-circulation loop (not shown), wherein flow rate, composition, temperature, and pressure are controlled in a predefined manner before re-circulating it to said inlet plenum for said first fluid. In a preferred embodiment the particles deposited on the outer surface of said hollow tubular members are at least partly removed from said surface by closing the outlet for said first fluid e.g. by closing a valve. Thereby substantially all of said first fluid permeates said membrane wall and clean the surface by back flushing. If said closing of the valve is very fast a back chock (short pressure pulse is obtained). It is further advantageous if said hollow tubular member is made from an elastic material so it is capable of expanding during said pressure pulse. It should be understood that the vessel may further comprise an additional high surface area material in addition to the hollow tubular members shown on the figure.

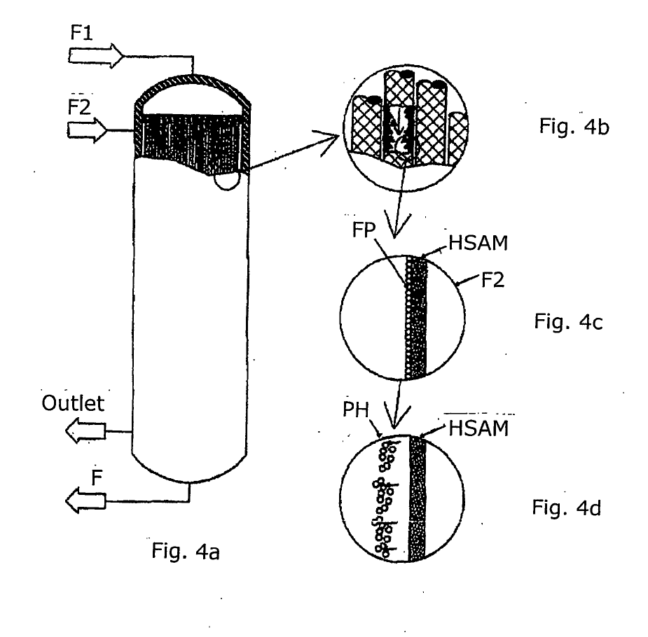

FIG. 5 shows an example of superimposed layers of hollow tubular members where two different fluids (A and B) can be conducted through the lumen of the fibres, as indicated, whereas a flow of a third fluid can be passed transversely through the fibres from above, perpendicular to the longitudinal direction of the fibres, as indicated by the vertical arrow.

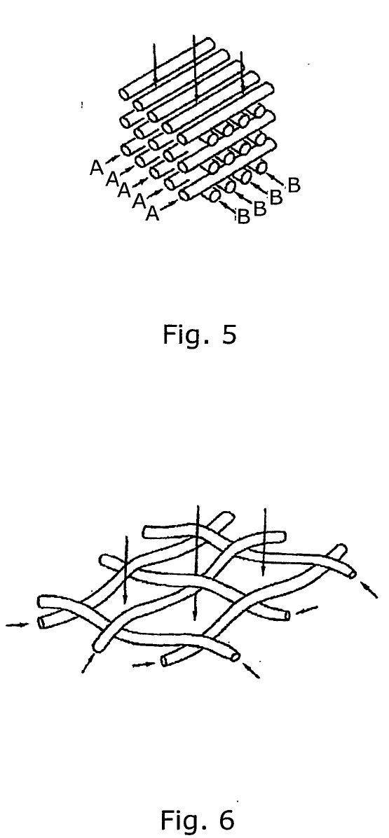

FIG. 6 illustrates a situation similar to the one in FIG. 6, but where a woven array of hollow membrane fibres is used.

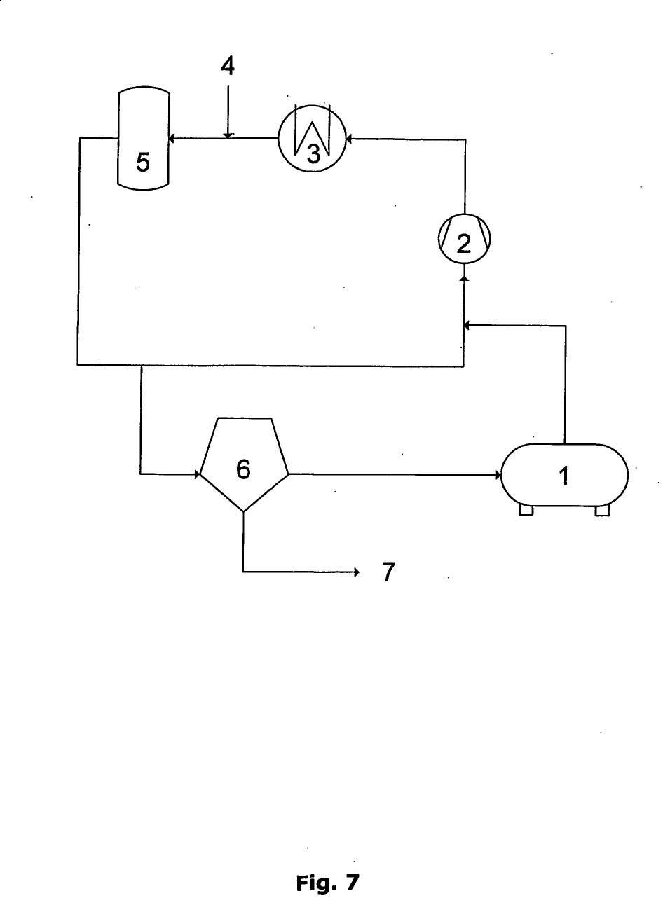

FIG. 7: illustrates a schematic representation of a generalized process layout of a preferred embodiment according to the present invention. The embodiment includes a supercritical reactor vessel with a material (5). A fluid from the fluid storage (1) Is fed to the supercritical reactor vessel (5) at a controlled rate and under controlled conditions by means of the compressor (2) and a heat exchanger (3) for adjustment of fluid temperature. The compressor and heat exchanger forms the recirculation loop utilized for continuous control of the reactor conditions, particularly temperature and fluid composition. The fluid is withdrawn from the reactor through the separator (6), and recycled to the fluid storage (1). The alcohol produced in the reaction may be recollected in the separator (6) either during the reaction period, by circulating a purge stream of the supercritical fluid through the fluid storage (1).

The preparation of the fine particles may involve the following 3 steps:
1. Introduction of metal alkoxide or other pre-cursor into the supercritical reactor
2. introduction of the reaction promoter into the reactor
3. adjusting the reaction temperature and pressure to the desired level

Step 1, introduction of pre-cursor, may be performed by spraying a solution of the pre-cursor over the filling material of the reactor, while maintaining pressure and temperature in the reactor below the solubility limit of the pre-cursor, or by introducing a supercritical solution of the pre-cursor to the reactor, and reducing the solubility of the pre-cursor below the saturation point by appropriate change of pressure or temperature, and thereby causing a deposition of the pre-cursor on the filling material surface. The supercritical pre-cursor solution may be produced by introducing the pre-cursor solution through (4), while maintaining the supercritical solvent properties at an appropriate level by means of the recirculation loop.

In one embodiment supercritical solvent at appropriate conditions may be used to remove the solvent of the pre-cursor solution before entering into step 2.

In step 2, the reaction promoter, preferably water, is introduced into the reactor. The introduction might take place by introducing the promoter directly into the reactor, or by introducing an at least partly saturated supercritical solution of the promoter. In a preferred embodiment the partly saturated supercritical solution of the promoter is produced in an integrated recirculation loop, by introduction of the promoter through (4).

The adjustment of reaction conditions in step 3 may be performed by means of a re-circulation loop for temperature control, and introduction or withdrawal of supercritical solvent to adjust the pressure, and thereby the solvent capacity.

It is understood that step 2 and 3 may be performed simultaneously in the same recirculation loop, or in any sequence, i.e. step 2 before step 3 or vice versa.

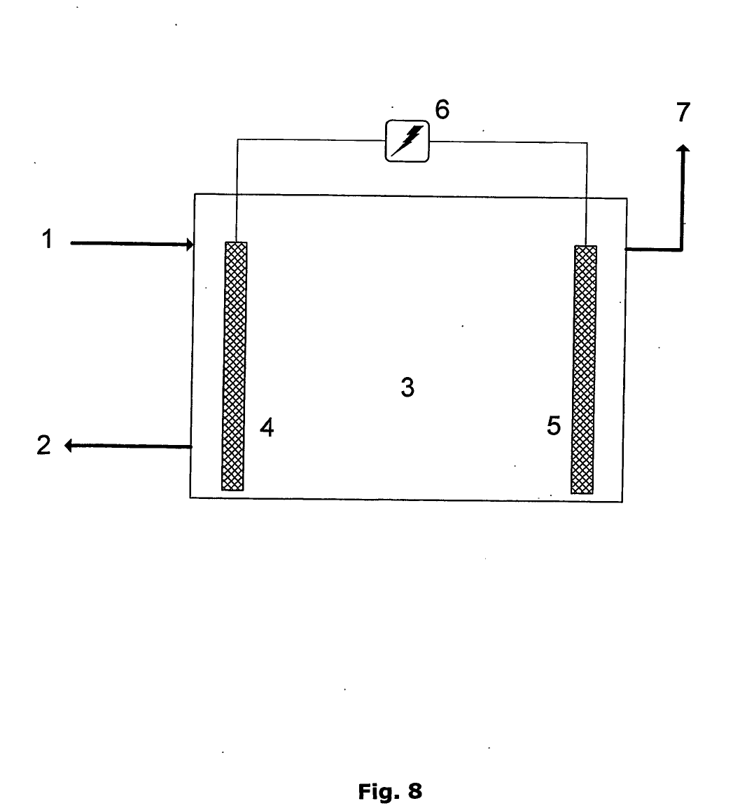

FIG. 8 shows schematic diagram of an in situ production alkoxide precursor according to the present invention. The figure illustrates an electrochemical synthesis of said metal alkoxides being introduced at (4) in FIG. 7. The in-situ production may be provided by implemented using an anode (4) constructed from the metal to be transformed into the alcoxide, and a standard cathode (5). The electrodes are Immersed into the alcohol solvent (3), and a suitable electric potential may be applied by means of a voltage generator (6). The electrical conductivity of the alcohol solvent may be improved by addition of an organic salt or other suitable ionic species. The chemical reactions taking place may be:
Anode: Me->Meⁿ⁺+n e⁻
Cathode: 2 ROH+2 e⁻->2 RO⁻+H₂
Solution: Meⁿ⁺+n RO⁻->Me(OR)ₙ
in which Me denotes the metal, ROH the alcohol and Me(OR)ₙ a metal alkoxide. The overall reaction is reduced to:
Me+n ROH->Me(OR)ₙ+n/2 H₂

The formed hydrogen may be withdrawn through a vent (7), and the remaining metal alkoxide solution may be withdrawn and introduced into said supercritical reactor through the outlet (2). The alcohol may be replenished through (1). Any ionic species added to modify the electrical conductivity of the solution may preferably be selected so as to be recollected with the excess alcohol, or purged out of the supercritical reactor during the pressurized state.

### ILLUSTRATIVE EXAMPLE 1

### Reactive Production of Fine particles as a Nanocrystalline Powder

A preferred embodiment according to the present invention may be production of a fine particle material comprising nano-crystalline primary particles.

A generalized scheme for a batch process for production of a fine particles comprised by primary particles may involve the following consecutive steps:
a. a dynamic pressurisation period,
b. one or more reaction period(s) at elevated pressure,
c. a depressurisation period.

A generalized schematic process diagram suitable for such production of fine particles in the form a powder comprising nanoscaled primary particles according to the present invention is disclosed in the FIGS. 7-8, and the numbers below refers to these drawings.

The reactor (5) comprises one or more sections of a material for deposition of said primary particles. The material may be introduced into said vessel in the beginning of the method and withdrawn from said vessel at the end of the method, but preferably the material for powder production may be reused multiple times. The presence of the material within the vessel during the method may generate one or more of the following advantages in a least part time of the method:
a. It serves as a flow distributor, thereby improving the distribution of said fluid(s) and/or substances being introduced and enabling a very precise control of the flow-, concentration-, pressure-, temperature- and density profiles within said vessel. A result from this improved distributing effect may be that more uniform and homogeneous primary particles are being produced.
b. It provides a large number of nucleation sites so as to provide a high nucleation rate compared to the growth rate of the primary particles. Hereby, a seeding effect and/or a catalytic effect is/are introduced, thus ensuring a further improved control of the primary particles being formed.
c. It serves as a collecting medium for effectively collecting the primary particles formed.
d. The material with said primary particles deposited on the surface may comprise the final product.

The material may have any shape and comprise a number of different materials depending on the specific embodiment and application. The properties of the primary particles being formed by the method may at least partly be controlled by the selection of the material. Typically the material is selected from one or more of the following criteria:
a. It should be able to withstand the operating conditions such as the temperature during said method according to the present invention,
b. It should be able to adsorb at least one of the reactants on the surface.
c. It should preferably have a high specific surface area.
d. It should allow ease of separation of said primary particles formed from said material, if the final product is not comprised by said primary particles on said surface of said material.

In the pressurisation period, the reactor vessel (5) is pressurised by adding one or more fluid(s) to the vessel to the vessel until the pressure in the reactor vessel exceeds the desired pressure for production of a powder comprising primary particles according to the present invention. The temperature in the reactor vessel may be controlled by conventional means such as controlling the inlet temperature of said fluid(s) to the reactor vessel in a heat exchanger (3) before introducing said fluid(s) into said reactor vessel, and/or the temperature of the walls in said reactor vessel, e.g. by applying a jacketed reactor vessel with a heating or cooling fluid, electrical heating etc.

The rate of pressure increase may be constant, but many embodiments according to the present invention involve a rate of pressure increase, which may vary according to a pre-selected schedule. Hence, many embodiments of the present invention involve controlling the rate of pressure increase to a pre-selected level e.g. the rate of pressure increase may typically be in the range 0.05-100 bar/min, such as in the range 0.1-20 bar/min and preferably in the range 0.1-15 bar/min, such as in the range 0.2-10 bar/min.

Particularly, the rate of pressure increase may be controlled to a pre-selected rate in at least part of the pressurisation period for economic reasons i.e. the pump or compressor size required may grow uneconomically big, and/or because the energy consumptions grow uneconomical and/or because the material in the vessel may not be able to withstand the pressure rates being applied, and may loose its mechanical integrity.

In many embodiments according to the present invention, the rate of pressure increase may be controlled in the range 40-120 bars such as in the range 60-110 bars, and particularly in the range 65 to 110 bars. In a preferred embodiment according to the present invention the rate of pressurisation in the interval 40 to 120 bars is at the most half of the maximum pressurisation rate outside this pressure range such as maximum one third of the maximum pressurisation rate this pressure range, and preferably at the most one fifth of the maximum rate of pressurisation outside this pressure range, such as maximum one tenth of the maximum rate of pressurisation outside this pressure range

One or more reactant(s) may be introduced into the reactor vessel before starting pressurisation period, but many preferred embodiments according to the present invention may involve introducing at least one of said reactant(s) during said pressurisation period or prior to said one or mire reaction period(s). In embodiments, wherein said one or more reactants are being introduced before or during said pressurisation period, this may be performed by spaying a fluid containing said one or more reactant(s) over said material.

The pressurisation is performed by feeding one or more fluid(s) from a fluid storage (1) by one or more pump(s) and/or compressor(s) (2).

Said fluid storage may comprise a plurality of storage(s) for said fluid(s) so as to handle more than one fluid. The fluid(s) being fed to said reactor may comprise a gas or/a liquid form of said fluid(s) or a combination of the two. For embodiments, wherein at least one of the fluid(s) is/are fed from said storage(s) in a liquid form, said liquid(s) is/are typically fed to an evaporator before introduction to said reaction vessel or mixing with another fluid and/or fluid mixture prior to introduction to said reactor vessel.

The pressure and temperature of fluid and/or fluid mixture in the reactor vessel after the pressurisation period are in many embodiments of the present invention maintained at a level, wherein at least one of said fluid(s) are in a supercritical state. The desired state of said supercritical fluid(s) prior to said reaction period may typically be selected so as to obtain a specific solubility of at least one reactant for said subsequent chemical reaction. Typically the pressure of said fluid(s) or fluid mixture in said reactor vessel may be in the range 85-500 bar such as in the range 100-300 bar prior to said reaction period.

As the pressurisation of said reactor vessel is achieved by introducing said fluid(s), and as the fluid generally is compressible, further compression takes place in the reactor vessel. The heat of compression may lead to a significant uncontrolled temperature increase in large vessel. If for example, carbon dioxide is compressed from 1 bar to 200 bar, the corresponding adiabatic temperature increase exceeds 100 C., which may lead to non-homogeneous reaction conditions within said reactor vessel, leading to undesirable large variations of said powder product to be produced in a method according to the present invention.

It is obvious to one skilled in the art, that the presence of a solid porous filling material in a significant part of the reactor vessel may hinder the extraction of heat through the vessel walls, as convective heat transfer is hindered, and the effect of this hindrance is proportional to the distance from the vessel centre to the vessel wall.

This may lead to undesirable large variations in the pressure- temperature- and density profiles within the vessel, which again may lead to reduced control of the primary particle formation reaction(s) in the subsequent reaction period(s) and/or may affect the mechanical integrity of said material being present in said one or more section(s) in said reactor vessel.

Hence, a preferred embodiment may involve controlling the pressure-, temperature- and/or density profiles within said reactor vessel during at least part time of said pressurisation period(s), by re-circulating at least part time of the method a part of the fluid contained in the vessel, the re-circulating comprising withdrawing from the reactor vessel at least part the fluid contained in the vessel, and withdrawing it to an external re-circulation loop for conditioning by e.g. extraction or addition of heat, and subsequently feeding the fluid to the vessel. The re-circulation during the pressurisation period enables very uniform and/or homogeneous reaction conditions with said reaction vessel prior to said reaction period(s). The re-circulation may further avoid excessively long pressurisation period(s) in order to achieve such preferred uniform reaction conditions, by enhancing the mass- and heat transfer rates in said reactor vessel. In a preferred embodiment according to the present invention the fluid in said re-circulation loop is in substantially, the same thermo-dynamical state as the fluid contained in said in the vessel, I.e. a gaseous state or a supercritical state.

Many embodiments according to the present invention involve one or more sol-gel reaction(s). In many of such embodiments a sequential or stepwise addition of said reactant(s) for said sol-gel reaction(s) is greatly preferred.

Often the least soluble reactant is introduced into the reactor vessel first. If for example the sol-gel reaction(s) involving the reaction between one or more alkoxide(s) and water, the alkoxide(s) may advantageously be introduced into the reactor vessel prior to introducing water. In a preferred embodiment said alkoxide(s) may be evenly distributed such as adsorbed or impregnated or coated on said the surface of said material being present In said one or more section(s) of said reactor vessel prior to introducing water.

The introduction of said alkoxide(s) may be introduced in a number of ways. The introduction may be performed by spraying a solution of said alkoxide(s) over said material, while maintaining pressure and temperature of said alkoxide(s) below the solubility limit(s) of said alkoxide(s). In another embodiment one or more supercritical fluid(s) with said alkoxide pre-cursor(s) dissolved and/or dispersed may be introduced into said vessel. Subsequently the density of said supercritical fluid(s) are decreased to a level below the solubility limit of said dissolved alkoxide(s) e.g. by a appropriate change of the pressure and/or temperature of said fluid, thereby causing a deposition of said alkoxide(s) on the surface of said material. In a still further embodiment the alkoxide(s) may be introduced into the vessel e.g. as dissolved in the corresponding alcohol, and said deposition of said alkoxide(s) obtained by introducing an antisolvent for said alcohol such as supercritical CO₂, and thereby causing said alkoxide(s) to precipitate on the surface of said material. The supercritical CO₂ containing said dissolved alcohol may be withdrawn to the above described re-circulation loop for separation.

All the above described embodiments generally result in said alkoxide pre-cursor(s) being substantially uniformly distributed on the surface of said material being present in said one or more sections of said reactor vessel.

Subsequently another reactant(s) such as water may be introduced to said reactor vessel, preferably being dissolved in and/or mixed with a supercritical fluid. Said reactant(s) reacting with said weldistributed alkoxide(s) on the surface of said material, and thereby causing primary particles to be formed on said surface of the material.

In some preferred embodiments according to the present invention, said sequential addition or stepwise addition may be repeated multiple times. The individual steps may comprise addition of the same reactants as added in the prior steps, or may comprise addition of new reactant(s).

The temperature and/or pressure may be maintained constant in some and/or all of the sequential steps, or may vary according to a pre-selected schedule.

Many preferred embodiments according to the present invention may further involve withdrawing from the reactor vessel at least part of the fluid contained in said vessel to a re-circulating loop for conditioning in at least part time of said one or more reaction period(s), or between said reaction period(s). In addition to controlling said pressure-, and/or temperature and/or density profiles according to a pre-selected schedule in some and/or all said reaction periods, said re-circulation may further control concentration profiles e.g. by adding reactant(s) and/or extracting a reaction product(s) in at least part time of said reaction period(s) and/or between said reaction period(s).

In many embodiments according to the present invention the reactor vessel is depressurised, when the reaction period(s) is/are completed. The depressurisation may be performed in by applying similar suitable principles as described above for the pressurisation period(s). The fluid(s) may to a large extentent be recovered during the depressurisation and recycled to the fluid storage(s).

The material comprising said primary particles on the surface produced according to the above description may comprise the final product. In such embodiments the product are extracted from the reactor vessel after the de-pressurisation period. Such products may further be subjected to an annealing process, such as a microwave annealing process.

In other embodiments the final fine particle product may constitute a powder comprised by said primary particles. Said primary particles may be easily separated from said material by introducing a vibrating effect and/or an acoustic effect such as ultra sound waves and/or by applying a back flushing effect, and/or a back shock effect and/or a back pulse effect.

In many embodiments of the present invention said powder product obtained by applying such means as described above comprises soft loosely bounded agglomerates, which are easily broken down to said primary particles by further processing. Said loosely bounded agglomerates may be easily collected by conventional separation means such as in a bag house filter or in a ceramic filter.

In a particularly preferred embodiment according to the present invention comprises separation of said powder product from said material within the vessel subsequent to said reaction period(s), thus allowing for semi-continuous or continuous operation. In such embodiment the method do not comprise said pressurisation and depressurisation periods described above.

In many embodiments according to the present invention powder product may have a high surface area such as measured by the BET method. The BET area of said powder product comprised by said primary may be at least 100 m2/g, such as at least 150 m2/g, preferably at least 200 m2/g such as at least 250 m2/g, and even more preferably at least 300 m2/g.

The present invention as illustrated in some preferred embodiments often allow very uniform and very homogeneous fine particle products to be produced at lower temperatures and/or shorter reaction times than prior art techniques. Typically a highly crystalline product may be obtained according to an embodiment of the present invention. For clarity the crystallinity in this context shall preferably be interpreted as the weight ratio of a crystalline phase to the total weight of said fine particle material formed.

In many embodiments according to the present invention the crystallinity may be tuned to a specific level e.g. a crystallinity of more than 10 weight %, such as a crystallinity of more 30 weight %, preferably more than 50 weight % such as more than 70 weight %, and preferably more than 85 weight % such as substantially a crystalline material. In many embodiments according to the present invention the normally required post processing treatment steps such as drying and calcination steps are therefore eliminated or substantially reduced.

Due to the very precise and easy control of the process parameters in many embodiments according to the present invention, such embodiments are further considered to be suitable for large scale production.

### ILLUSTRATIVE EXAMPLE 2

An apparatus according to an embodiment of the present invention may include
Reaction vessel assembly
Dosing assembly for precursor and chemical reactor
CO₂ recycle system
Internal discharge assembly
External filter and product collection assembly
CO₂ storage assembly

The reaction vessel may be a vertical or a horizontal vessel. In a preferred embodiment a vertical vessel is used for facilities with a small production capacity and horizontal vessels are preferably used for facilities with large production capacity. In each case vessels may be arranged in parallel for optimal plant configuration as determined by a man skilled in the art.

The reaction vessel may be equipped with one or more sections of high surface area material. The material is preferably arranged in a manner that allows easy cleaning and discharge from the high surface area material of the produced chemical reaction products.

Without limiting the scope of the invention the high surface area material may be hanging sheets of high surface area materials, hanging bags of high surface area materials or a honey come structured material. The reaction vessel further contains means for discharging the chemical reaction products from the high surface area material by using ultrasound, sonic horns, mechanical shaking, electrostatic discharge forces or any combination hereof.

The reaction vessel contains in the lower part means for collection and transport of the chemical reaction products. In a preferred embodiment a collection is performed using a mechanical conveyor that transports the formed particulate product to one end of the reaction vessel, where it is discharged into a pneumatic CO₂ transport system, which transport the products to an external filter and debagging system.

1-147. (canceled)

148. A method of producing a fine particle material comprising:
introducing one or more substances contained, such as dissolved and/or dispersed in one or more fluid(s) into a vessel by introducing said fluid(s) into the vessel, said vessel containing one or more section(s) comprising a material, at least one of the fluids being in a supercritical state before or after being introduced into said vessel,
causing and/or allowing, said substances to precipitate at least partly as primary particles on the surface of said material,
wherein at least one of said substances undergoes a chemical reaction,
wherein at least one said substances undergoing a chemical reaction is an alkoxide, and
wherein said alkoxide comprises a metal- or semi-metal alkoxide,
wherein the method further comprises:
introducing into the vessel at least one of reactant(s) and/or precursor(s) and/or initiator(s) and/or catalyst(s) for said chemical reaction; and
subsequently introducing into the vessel said one or more substances dissolved and/or dispersed in at least one fluid.

149. The method according to claim 148, wherein said chemical reaction(s) is/are a sol-gel reaction(s).

150. The method according to claim 148, wherein the average diameter of said nanoscaled primary particles is smaller than 100 nanometer such as smaller than 30 nanometer, preferably smaller than 20 nanometer, and even more preferable below 15 nanometer such as below 10 nanometer.

151. The method according to claim 148, wherein the standard deviation of the size distribution of said primary particles formed is less than 60% of the average diameter of said primary particles, such as 40% of the average diameter of said primary particles, and preferable less than 30% of the average size of said primary particles, and even more preferable less than 20% of the average size of said primary particles such as less than 15% of the average size of said primary particles.

152. The method according to claim 148, wherein the standard deviation of the size distribution of said primary particles formed is maximum 20 nanometer, such as maximum 10 nanometer, and preferably less than 5 nanometer, and even more preferably less than 3 nanometer.

153. The method according to claim 148, wherein at least one of said fluid(s) being in a supercritical state is selected from the group consisting of carbon dioxide, alcohols such as methanol, ethanol, propanol, isopropanol, buthanol, isobuthanol, pentanol, hexanol, water, methane, ethane, propane, buthane, pentane, hexane, cyclohexane, heptane, ammonia, sulfurhexafluoride, nitrous oxide, chlorotrifluoromethane, monofluoromethane, acetone, THF, acetic acid, citric acid, ethylene glycol, polyethylene glycol, N,N-dimethylaniline and mixtures thereof.

154. The method according to claim 148, wherein the pressure of at least one of said fluids is in the range 85-500 bar, preferably in the range 85-500 bar, such as in the range 100-300 bar.

155. The method according to claim 148, wherein the temperature in the vessel is maintained in the range 20-500° C., such as 30-450° C., and preferable in the range 35-200° C., and more preferable in the range 40-150° C.

156. The method according to claim 148, wherein said fluid further comprises at least one co-solvent.

157. The method according to claim 148, wherein said precipitation is provided/caused by a change in the solubility of at least one of said substances is due to an antisolvent present in the vessel.

158. A method of producing a fine particle material comprising
introducing one or more substances contained, such as dissolved and/or dispersed in one or more fluid(s) into a vessel by introducing said fluid(s) into the vessel, said vessel containing one or more section(s) comprising a material, at least one of the fluids being in a supercritical state before or after being introduced into said vessel,
causing and/or allowing, said substances to precipitate at least partly as primary particles on the surface of said material,
wherein said precipitation is provided/caused by a change in the solubility of at least one of said substances, and wherein said antisolvent is one of the fluids being introduced to the vessel.

159. A method of producing a fine particle material comprising
introducing one or more substances contained, such as dissolved and/or dispersed in one or more fluid(s) into a vessel by introducing said fluid(s) into the vessel, said vessel containing one or more section(s) comprising a material, at least one of the fluids being in a supercritical state before or after being introduced into said vessel,
causing and/or allowing, said substances to precipitate at least partly as primary particles on the surface of said material,
wherein said precipitation is provided/caused by a change in the solubility of at least one of said substances, and wherein said change in solubility of at least one of said substances is provided/caused by expanding at least one of said fluids containing at least one of said substances into the vessel.

160. The method according to claim 158, wherein at least one of said substances undergoes a chemical reaction, and wherein said chemical reaction(s) is/are a sol gel reaction(s), and wherein the maximum temperature in the vessel during said sol-gel reaction(s) is maintained below 400 C., such as below 300 C., preferably below 250 C. such as below 200 C., and even more preferably below 150 C. such as below 100 C.

161. The method according to claim 160, wherein at least one of said substances undergoing a chemical reaction is an alkoxide, and wherein said alkoxide comprises a metal- or semi-metal alkoxide, comprising:
introducing into the vessel at least one of said reactant(s) and/or precursor(s) and/or initiator(s) and/or catalyst(s) for said chemical reaction; and
subsequently introducing into the vessel one or more substances dissolved and/or dispersed in at least one fluid.

162. The method according to claim 160, wherein at least one of said substances undergoing a chemical reaction is an alkoxide, and wherein said alkoxide comprises a metal- or semi-metal alkoxide, comprising multiple subsequent steps of
introducing into the vessel at least one of said reactant(s) and/or precursor(s) and/or initiator(s) and/or catalyst(s) for said chemical reaction; and
subsequently introducing into the vessel one or more substances dissolved and/or dispersed in at least one fluid.

163. The method according to claim 162, wherein said material in said one or more section(s) is capable of adsorbing at least one of said reactant(s) and/or precursor(s) and/or catalyst(s) on said material.

164. The method according to claim 163, wherein said reactant(s) and/or precursor(s) and/or catalyst(s) is/are adsorbed substantially in a monolayer of said material.

165. The method according to claim 164, wherein the time for said chemical reaction(s) is less than 24 hours, such as less than 12 hours and preferable less than 8 hours, and even more preferable less than 4 hours.

166. The method according to claim 164, wherein the time for said chemical reaction(s) is maximum 2 hours, such as maximum 1 hour, preferably less than 30 minutes and even more preferably less than 15 minutes.

167. The method according to claim 166, wherein said material present in said one or more section(s) of said vessel, comprises additional nucleation sites, and wherein said material present in said one or more section(s) of said vessel, provides a seeding effect, and wherein the number of nucleation sites is further increased by introducing an ultrasound and/or a vibrating surface effect, and wherein said material present in said one or more sections is a template for forming said primary particles into a specific shape, size, structure or phase.

168. The method according to claim 167, wherein said primary particles being produced is a least partly crystalline.

169. The method according to claim 166, wherein said material present in said one or more section(s) of said vessel, provides a distributing effect of said fluid(s) being introduced into said vessel, and wherein said material present in said one or more sections comprises a porous structure such as a sheet, a spongeous or a grid structure.

170. The method according to claim 166, wherein said material present in said one or more section(s) of said vessel, provides a distributing effect of said fluid(s) being introduced into said vessel, and wherein said material present in said one or more sections is a fibrous material.

171. The method according to claim 170, wherein said material present in said one or more sections has/have a hydrophilic surface.

172. The method according to claim 171, wherein said material is a polymer material.

173. The method according to claim 169, wherein said material is a ceramic material, and wherein said material is an aerogel.

174. The method according to claim 173 comprising:
producing said aerogel material by a sol-gel reaction in an organic solvent;
removing said organic solvent by extraction in supercritical CO₂;
drying at least partly said aerogel; and
forming said primary particles on the surface of said aerogel by the method of claim 1.

175. The method according to claim 174, wherein the specific surface area (m²/m³) of said material in said sections is above 500 m²/m³, such as 1000 m²/m³, such as above 10.000 m²/m³, and preferably above 50.000 m²/m³ such as above 100.000 m²/m³.

176. The method according to claim 174, further comprising re-circulating at least part of a fluid mixture present in the vessel, wherein the re-circulating comprises:
withdrawing from the vessel at least a part of a fluid from the vessel and feeding it to a re-circulation loop and subsequently feeding the fluid back to the vessel.

177. The method according to claim 174, further comprising controlling the temperature of the fluid in the re-circulation loop.

178. The method according to claim 177, wherein heat is added or extracted from the fluid in the re-circulation loop.

179. The method according to claim 176, wherein one or more reactant is added or extracted from the fluid in the re-circulation loop.

180. The method according to claim 176, wherein at least one of the reactants is an alcohol an alkoxide or water, and wherein a metal or semi-metal alkoxid is produced in situ in the process prior to being introduced to said vessel by said fluid.

181. The method according to claim 180, wherein said material present in said one or more sections in vessel with said precipitated primary particles thereon comprises the final product.

182. The method according to claim 181, wherein said product comprises primary particles deposited on a carrier film such as a tape cast.

183. The method according to claim 181, wherein said primary particles on said surface of said material constitutes a film or a coating.

184. The method according to claim 182, wherein said film or coating has one or more layer(s) each layer having a layer thickness of up to 1 micron, such as a layer thickness below 500 nanometer, preferable a layer thickness below 250 nanometer such as a layer thickness below 100 nanometer.

185. The method according to claim 182, wherein said film or coating has one or more layer(s) having a layer thickness that is below 50 nanometer.

186. The method according to claim 183, wherein said coating comprises multiple layers.

187. The method according to claim 184, wherein the layers comprise different materials.

188. The method according to claim 186, wherein said product is further subjected to an annealing process.

189. The method according to claim 188, wherein said annealing process is performed by microwaves.

190. The method according to claim 189, wherein said primary particles are deposited on the surface of said material in the form of individual particles or small clusters of individual particles.

191. The method according to claim 189, wherein said small clusters comprise less than 10 atoms.

192. The method according to claim 189, wherein said primary particles precipitated on said surface of the material present in said one or more section(s) are removed from said material as a powder.

193. The method according to claim 192, wherein said powder has weakly bounded agglomerates of a size of maximum 10 micron, such as up to 5 micron, and preferably up to 1 micron such as up to 500 nanometer.

194. The method according to claim 193, wherein said powder is removed from said material by introducing a vibrating effect and/or an acoustic effect such as ultrasound waves and/or by back flushing and/or by applying an pressure pulse effect.

195. The method according to claim 193, wherein said fluid containing said formed powder is fed into a second vessel containing a liquid.

196. The method according to claim 193, wherein said vibrating effect is generated by a magneto restrictive means, and wherein said removal of said powder is performed according to a back flush or back pulse or a back chock technique, and wherein said fluid containing said formed powder is expanded into said liquid thereby providing said formed powder material as a dispersion in said liquid.

197. The method according to claim 193, wherein said vibrating effect is generated by a magneto restrictive means, and wherein said removal of said powder is performed according to a back flush or back pulse or a back chock technique, and wherein said fluid containing said formed powder is fed to a bag filter or ceramic filter for separation of said formed powder material from the fluid.

198. The method according to claim 193, wherein said vibrating effect is generated by a magneto restrictive means, and wherein said removal of said powder is performed according to a back flush or back pulse or a back chock technique, and wherein said fluid containing said formed particulate material is fed to a membrane separation device.

199. The method according to claim 193, wherein said vibrating effect is generated by a magneto restrictive means, and wherein said removal of said powder is performed according to a back flush or back pulse or a back chock technique, and wherein said formed powder contained in said fluid is deposited on to a second solid in a second vessel.

200. The method according to claim 199, wherein said primary particles comprise an electro-ceramic material.

201. The method according to claim 199, wherein said primary particles comprise a semi-conducting material.

202. The method according to claim 199, wherein said primary particles comprise a magnetic, ferromagnetic, paramagnetic, or superparamagnetic material.

203. The method according to claim 199, wherein said primary particles comprises a core-shell structure.

204. The method according to claim 199, wherein said core comprises a magnetic or ferro magnetic core.

205. The method according to claim 199, wherein said primary particles comprise a piezoelectrical material.

206. The method according to claim 205, wherein said piezoelectrical material comprises lead zirconate titanate, Pb (Zr_{0.52},Ti_{0.48})O₃.

207. The method according to claim 199, wherein said primary particles comprises oxide(s), oxyhydroxide(s), hydroxide(s) such as metal oxide(s), semi-metal oxide(s), metal oxyhydroxide(s), semi-metal oxyhydroxide(s), metal hydroxide(s), semi-metal hydroxides and combinations thereof.

208. The method according to claim 207, wherein said oxides comprise oxides of one or more of the following elements: Al, Si, Ti, Zr, Zn, Fe, Ni, Co, Ce, Ge, Ba, Sr, W, La, Ta, Y, Mn, V, Bi, Sn, Te, Se, Ga, Be, Pb, Cr, Mg, Ca, Li, Ag, Au, Pt, Pd, Cd, Mo, or Eu and combinations thereof.

209. The method according to claim 207, wherein said oxides are silica, aluminia, zirconia, or titania and combinations thereof.

210. The method according to claim 207, wherein said primary particles comprise carbide(s) or nitride(s).

211. The method according to any claim 207, wherein said metal or semi-oxide(s) is/are precursor(s) for a thermoelectric material.

212. The method according to claim 207, wherein said primary particles deposited on the surface of said surface provide an antibacterial surface.

213. An apparatus comprising the product made by the method of claim 212.

214. A product obtained by the method of claim 148.

215. A composition comprising a hard nanocrystalline coating that comprises primary particles of Al₂O₃ and ZrO₂ according to claim 207, wherein said coating has a hardness of at least 10 GPA.

216. A composition comprising a hard nanocrystalline coating that comprises primary particles of Al₂O₃ and ZrO₂ according to claim 207, wherein said coating has a scratch and wear resistance of at least 30 N.

217. A composition comprising a hard nanocrystalline coating according to claim 215, further comprising primary particles of ZnO.

218. A hard nanocrystalline coating according to claim 216, wherein said coating is applied to a polymer or a glass material.

219. A mechanical part with a hard nanocrystalline coating according to claim 218, wherein said coating is applied to the surface of said mechanical part.
